(19) United States
(12) Patent Application Publication
(10) Pub. No.: US 2002/0138414 A1
(43) Pub. Date: Sep. 26, 2002

(54) Method and system and article of manufacture for a rules based automated loan approval system

(76) Inventor: Charles Pitman Baker IV, Colleyville, TX (US)

Correspondence Address: Gary R. Maze, Duane, Morris & Heckscher LLP, One Greenway Plaza, Suite 500, Houston, TX, 77046, US

(21) Appl. No.: 09/817,626

(22) Filed: Mar. 26, 2001

(51) Int. Cl. G06F 17/60

(52) U.S. Cl. 705/38

(57) ABSTRACT

A system for and method of automation of evaluating, approving, and underwriting loans for a borrower requesting a loan from a lender at a vendor location. The system comprises a computer system having a database that further comprises vendor data, lender data, and at least one loan tier; a data communications network operatively in communications with the computer system; an input terminal; loan processing software operatively resident in the computer system for evaluating the borrower information and information from the one or more sources of financial information according to the approval criteria of at least one lender and approving or rejecting a borrower's request for a loan from the at least one lender; and an output device. The method comprises obtaining a predetermined set of borrower information from the borrower, including data regarding the item to be purchased; having the vendor access a display form maintained or otherwise associated with a lender, such as a web page accessible over the Internet, for lenders with preexisting relationships with the vendor; selectively enabling the vendor with access to a loan approval display form; transmitting the borrower information and information about the item to be financed to an application validation and approval process; obtaining a predetermined set of credit information regarding the borrower; and validating and approving or rejecting the borrower request against the loan approval tiers.

### BACKGROUND OF THE INVENTION

1. Field of the Invention

The present invention relates to rules based loan approval systems and, in particular, to a new and improved system and method for wide-area communications enabled, rules based automated acceptance and processing of loan applications and approval of loans. By way of further particularity, the present invention relates to a new and improved system and method of Internet implemented, rules based acceptance and processing of loan applications and approval of loans without the need for human intervention in the loan approval process.

2. Description of the Related Art

The availability of more-or-less omnipresent data communication such as the Internet has given rise to greater accessibility to financial services on a twenty-four hour, everyday basis. Greater presence of such financial services has also given rise to increased competition among lenders to provide financial services in an economical, competitive manner.

Numerous proposals for provision of financial services exist in the art, including loan application systems, although very few loan approval systems have been proposed. In the art, these proposed systems generally proceed as follows:

accept and possibly store borrower attributes into a database as entered by a potential borrower requesting a loan, via a global telecommunications network;

accept and possibly store credit related information regarding the potential borrower into the database as sent from at least one credit bureau;

store into the database respective loan acceptance criteria and respective loan attributes for an offered loan on a lender-by-lender basis;

compare the borrower attributes of the potential borrower with the loan acceptance criteria stored in the database to determine if the potential borrower qualifies for any available loans on a “meets” or “does not meet” basis without further, conditional decision processing; and

analyze loan attributes of the available loans to determine rankings of best loans.

In some prior art systems, the proposed system allows the borrower to choose one from a plurality of loan providers who may be willing to review the borrower's loan application as it has been submitted. In other prior art systems, an auction is enabled allowing competitive bids by lenders for a loan proposed by a borrower. Additionally, in the prior art a loan application may automatically be generated from the borrower attributes and automatically sent to a selected lender for loan approval.

However, in these proposed systems loan approval is still a human process requiring a human being to make a final determination. Therefore, these prior art systems are best characterized as loan application verification and forwarding systems.

One step generally missing from prior art loan application approval systems is the step of obtaining independent valuation of the goods sought to be secured by the loan. A second step generally missing from prior art loan application approval systems is the actual approval of the loan itself as part of the automated loan application evaluation process.

Some systems proposed in the prior art are for so-called business-to-business systems in which the point of origin of a request is a vendor. For example, U.S. Pat. No. 5,500,513 issued to Langhans, et al. for an “Automated purchasing control system” discloses an automated purchasing control system which can be customized for a corporate customer. Langhans '513 teaches a computer system having a database comprising criteria used for evaluation for remotely generated request. The system receives an authorization request over phone lines from a remote point-of-sale terminal and processes the request using unique software. The database is customized for a corporate user to establish that company's hierarchical structure. Elements of the hierarchical structure are independently reconfigurable, allowing a company to specify different hierarchical relationships in the software for authorization, billing, and reporting purposes. Different authorization tests can be established for each position in the hierarchy, with a particular position being required to pass not only its own test, but the test of elements higher in the hierarchical tree. However, Langhans '513 is not a loan approval method or system and neither teaches nor suggests obtaining valuation of the goods sought to be secured by the loan or completing the loan approval process.

U.S. Pat. Nos. 5,611,052, 5,930,776, and 6,029,149 issued to Dykstra, et al. for a “Lender direct credit evaluation and loan processing system” are also illustrative. In these patents, a system for loan processing includes a central processing unit which has capabilities for communicating with off-site remote access terminals as well as capabilities for communicating with credit bureau computers. In operation, the central processing unit is accessed from a remote terminal, loan application information is entered into the remote terminal, credit bureau information is accessed by the apparatus, credit scoring is performed, and a loan application is approved or declined. All steps, except for the entering of loan application information into the remote terminal, are fully automated. However, the Dykstra patents do not teach full loan underwriting and require a specific form of evaluation, credit scoring. The Dykstra patents do not teach flexibility in arranging differing tiers of credit rates and criteria or differing subtiers based on loan collateral or other criteria within a tier. Further, the Dykstra patents do not teach flexibly presenting or seamlessly integrating loan application forms or other methods of obtaining borrower information with another's system such as by a web page.

In other prior art, so-called consumer-to-business systems, a borrower may be shown the best rate loan from a group of lenders and asked to select from a presented list of lenders. For example, a consumer/potential borrower terminal may exist where a consumer enters private financial information. This information and credit information along with loan acceptance criteria are considered, and the borrower is sent a list of lenders from which to choose that may provide the loan. The borrower terminal may be a personal computer operatively connected to the system through the Internet and using an Internet browser.

U.S. Pat. No. 5,966,699 issued to Zandi is illustrative. In Zandi '699, a prospective borrower enters a loan application from a terminal. The application is submitted to a loan authorizer's computer over a computer network, and the loan authorizer then analyzes the loan application, either approving or disapproving the loan application. If approved, the loan application is entered into a database accessible to actual lenders who may then submit bids on that loan application. If bids are submitted, the borrower can then select from one of the bids. As with Langhans '513, Zandi '699 neither teaches nor suggests obtaining valuation of the goods sought to be secured by the loan or completing the loan approval process. Further, as with Langhans '513, Zandi '699 does not teach approving and funding a loan but instead verifies and processes the loan application, e.g. insures that the application is complete.

U.S. Pat. No. 5,940,812 issued to Tengel et al. is also illustrative. Tengel '812 teaches a loan origination system including an apparatus and method for automatically matching a best available loan to a potential borrower via a global telecommunications network. The loan origination system accepts and stores borrower attributes entered by a potential borrower requesting a loan into a database. In Tengel '812, this is accomplished via a global telecommunications network. The Tengel '812 loan origination system also accepts and stores into the database credit related information regarding the potential borrower sent from at least one credit bureau. The loan origination system stores into the database respective loan acceptance criteria and respective loan attributes for an offered loan. The loan origination system compares the borrower attributes of the potential borrower with all of the loan acceptance criteria stored in the database to determine any available loans for the potential borrower. The loan attributes of the available loans are analyzed to determine rankings of best loans and the rankings are made available to the borrower. From the rankings of best loans, the borrower may choose a selected loan provided by a selected lender. A loan application is automatically generated from the borrower attributes and is automatically sent to the selected lender for loan approval.

Prior art systems such as Zandi '699 and Tengel '812 teach having a borrower choose a lending institution and sending a loan application that has been checked for completeness (but not accuracy) electronically to that institution where a human being makes the ultimate approval decision. The institution most likely contacts the prospective buyer such as by phone or electronic mail to complete loan application. In any case, only the application for the loan is processed electronically, not the loan itself. These prior art systems are thus no more than query systems to inform the borrower that they may pre-qualify for a loan but do not approve the loan, especially over the Internet. Accordingly, since the borrower is usually only checking to see if he qualifies, the borrower may choose to not make the loan. Further, these systems do not teach flexibility in presenting forms or other methods of obtaining borrower information.

Accordingly, the prior art systems and methods do not address automated loan approvals. Instead, prior art systems and methods address gathering data from and about a requester, processing that data only to insure completeness of data provided, and forwarding the data to a human being who makes the loan approval decision. Further, in the prior art systems exist for loan requests but do not process, grant, reject, or underwrite an actual loan, that processing being left up to human beings.

The prior art systems do not check valuation of the goods to be secured by the loan, such as, by way of example and not limitation, using the National Automotive Dealers Association valuations for car, boat, or motorcycle values. Accordingly, the prior art systems gather data about the borrower and the transaction but leave out gathering data about the item to be purchased that will secure the loan.

Many prior art systems do not go through multiple loan rate and criteria tiers. Most prior art systems do not go through one or more subtiers in one or more tiers when evaluating loan queries, each subtier relating to one or more product types, e.g. car, home, mobile home, boat, or medical products.

### BRIEF DESCRIPTION OF THE DRAWINGS

FIG. 1 is a functional block diagrammatic representation of the present invention's apparatus;

FIG. 2 is an exemplar of a login display;

FIG. 3 is a flowchart of the present invention;

FIG. 4 is an exemplar of a system access display;

FIG. 5 is an exemplar of a portion of a borrower and loan data entry form display; and

FIG. 6 is an exemplar of a portion of an approved loan detail display.

### DETAILED DESCRIPTION OF THE PREFERRED EMBODIMENT

Prior art business-to-business Internet based approval systems tend to cater to retail establishments and their customers, thereby neglecting the lender. The present invention allows lenders to maintain their identity such as by an Internet web presence as the perceived loan originator who is also providing the application processing.

The present invention generally comprises a business-to-business, communications enabled, automated online loan approval and underwriting system. The preferred communications link is the Internet, although other communications media, protocols, and systems may be used, as will be understood by those of ordinary skill in the data communications arts.

The present invention provides lenders such banks, savings and loans, mortgage companies, credit unions, non-savings institutions, and the like with the ability to process loan requests instantly, behind the scenes, while maintaining a web presence as the loan originator and application processor.

The present invention electronically evaluates and approves loans rapidly, often in a matter of seconds. In the present invention, retail establishments, by way of example and not limitation such as car dealerships, home builders, boat dealerships, merchandisers, and the like, can directly access a lender's web page of their choice and get rapid loan approval while ready and willing customers wait. As opposed to the prior art that merely validates the completeness of a loan application, the present invention thus offers a business-to-business loan approval service for multiple industry sectors.

As further opposed to the prior art, the present invention allows lenders to continue to utilize their own loan underwriting criteria. This is important to lenders since establishing underwriting criteria with just the right mix that will perform at a predetermined level for that lender takes time, money, and experience. As opposed to other systems that implement scoring methods, summation methods, and the like, the present invention flexibly implements the loan evaluation and approval method preferred by and specified by each lender.

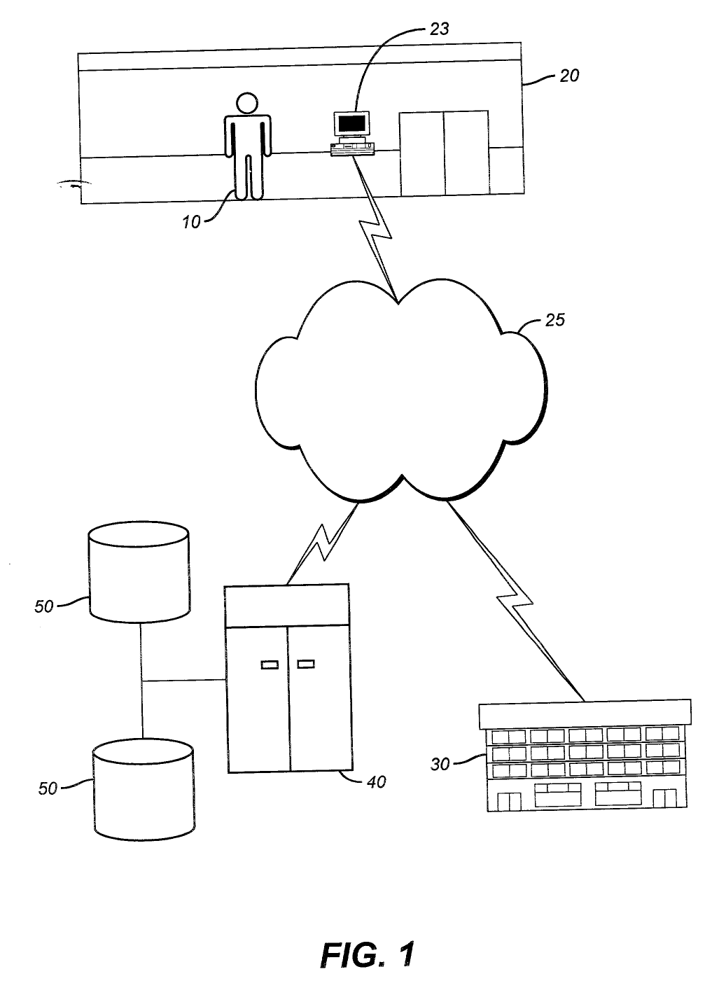

Referring now to FIG. 1, a schematic overview of the present system, the present invention comprises a scalable, low cost alternative to the old-fashion way of approving loans. Further, given redundancies in hardware and software available, the present invention may be used to provide a full-time approval system available around the clock, each and every day.

By allowing merchants instant loan approval seven days a week, twenty four hours a day while a borrower 10 is at a vendor site where a vendor 20 is offering the goods to be secured by the loan and borrower 10 is ready to buy, both lenders 30 and vendors 20 using the present invention may be able to close more loans.

Currently, rejected loan applications make up over fifty percent of all applications submitted to lender 30 that require further human processing. However, with the present invention, a loan processing department may never see rejected applications, thus freeing up critically needed staff to be utilized in other areas or decrease staff requirements altogether.

Further, human errors and inconsistencies in manual loan processing may be ameliorated by the present invention's use of a flexible, consistent, underwriting process that allows lenders 30 to set and use their own underwriting criteria, on a lender by lender basis.

Referring still to FIG. 1, database 50 resides at host 40. Database 50 can be a single database as that term is well understood by those of ordinary skill in the software database arts, or can comprise a plurality of databases 50. Each database 50 can further comprise a plurality of tables as that term is well understood by those of ordinary skill in the software database arts. In the currently preferred embodiment, at least one table will comprise loan evaluation and approval criteria for each lender 30 participating in the system.

Optionally, at least one table may exist to maintain vendor 20 and data about borrower 10, by way of example and not limitation for historical or tracking purposes or for other reasons such as verification of compliance with various regulations. However, as opposed to many prior art systems, data about borrower 10 need not be maintained for forwarding to lender 30 for loan approval because the system accomplishes the approval without the need for intervention by lender 30. Data about borrower 10 in a table such as a borrower table or borrower database 50 may comprise data required for financial evaluation such as, by way of example and not limitation, name, social security number, income, and other data, all of which will be well understood by those of ordinary skill in the financial arts. Additionally, data concerning the item to be purchased may also be resident in database 50. These data may reside a collateral table or in other transient or persistent data storage.

The present invention further allows categorization of items to be purchased with the loan, if approved, into classes comprising product types, by way of example and not limitation such as automobiles, housing, mobile or manufactured housing, boats, medical goods, household goods, appliances, jewelry, machinery, and the like, or any combination thereof.

Further, the present invention allows for the definition of tiers 60 (not shown in the Figures). As used herein, “tiers” means an aggregation of properties as that term is understood by those or ordinary skill in the software programming arts, such as by way of example and not limitation loan approval criteria, data describing goods, and other descriptive data, into interrogatable collections. By way of example and not limitation, one or more tiers 60 may be defined and implemented for lender 30 where each tier 60 corresponds to one of a set of classes of loan for lender 30, e.g. prime, “A” paper, and the like. Properties for a tier 60 may also include annual interest percentage rate, permissible durations of loans for that tier 60, and information required by statute.

Each tier 60 may thus describe rates and terms, underwriting criteria, and other decision or implementation criteria. Each tier 60 may differ from other tiers 60 for a lender 30 as well as between lenders 30.

In a preferred embodiment, one tier 60 exists for each class of loan. Additionally, each tier 60 may further have subtiers, each subtier relating to one or more classes of product types as described above. Further, each tier 60 may be configured to use different acceptance criteria or comprise different rate criteria for each subtier in that tier 60.

By way of example and not limitation, a “prime rate” tier 60 may have rates, terms, and so forth for classes comprising housing and machinery but for no other classes. Further, the acceptance criteria, loan rates, loan terms, and the like for the housing class within that tier 60 may differ from the acceptance criteria, loan rates, loan terms, and the like for the machinery class in that tier 60. Another tier 60, by way of example and not limitation a “prime-plus-two-percent” tier 60, may comprise acceptance criteria, loan rates, loan terms, and the like for all item classes in that “prime-plus-two-percent” tier 60. Thus, the present invention supports multiple classes of loan product types and multiple tiers 60, where each class and tier 60 may comprise its own underwriting criteria and characteristics independently from other tiers 60 and each tier 60 may further differentiate between loan criteria based on the collateral used to secure the loan within one or more tiers 60.

In the preferred embodiment, the present invention is a business-to-business system. Accordingly, access may be limited to lenders 30 and vendors 20. In the preferred embodiment, access is accomplished through wide area data communications 25 such as the Internet or an intranet controlled by lender 30 using terminals 23 located at the vendor site, where in the preferred mode terminals 23 are personal computers with Internet browsers, as that term is well understood by those in the software arts. As used herein, “input device” and “output device” may be different devices or may be a single device such as terminal 23. In presently considered alternative embodiments, terminals 23 may be hand held devices, special purpose data communications devices, kiosk resident devices, intelligent terminals, dumb terminals, other general purpose data communications devices such as television enabled devices, or the like, or any combination thereof. Further, wide area data communications may be accomplished via local area networks, direct connect networks such as terminal networks, dial-up access, broadband access such as digital subscriber link (DSL) or cable, wireless, T1 linkages or the like, Intranets, or any combination thereof.

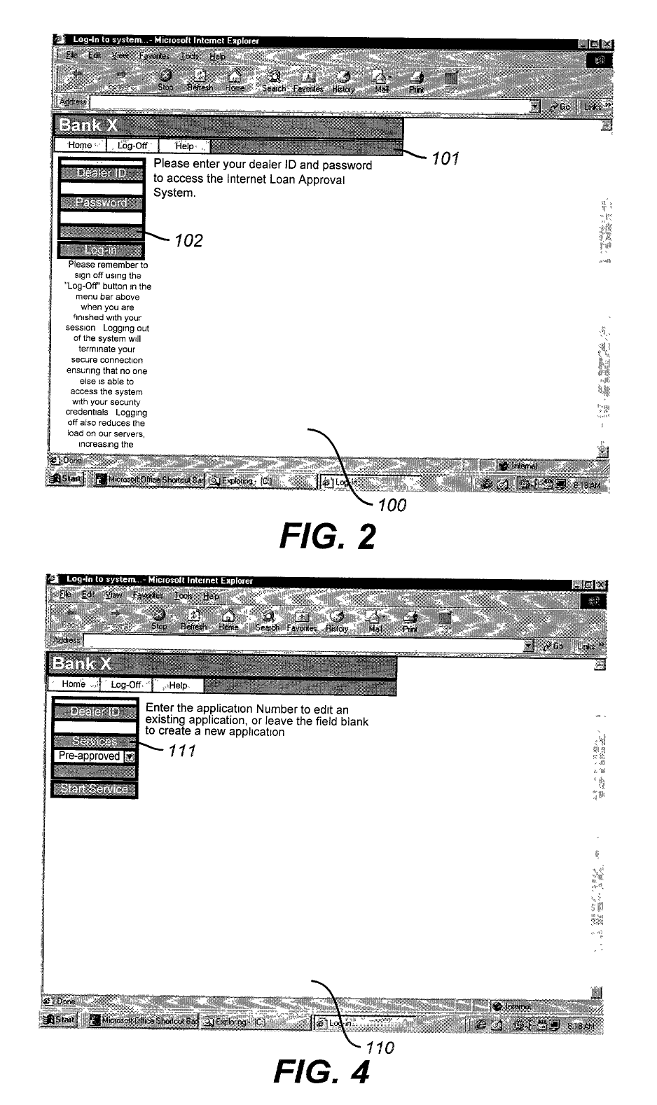

Referring now to FIG. 2, in the preferred embodiment each lender 30 maintains an Internet presence, and the present invention allows vendors 20 to access each lender 30 through the Internet by accessing one or more Internet enabled points of communication, by way of example and not limitation to web page 100. Web page 100 may have a banner 101 that identifies lender 30, or web page 100 may be displayed within a frame (not shown in the Figures), as that term is readily understood by those of ordinary skill in the browser display programming arts, that otherwise indicates lender 30.

Therefore, when vendor 20 accesses the present system, in the preferred embodiment that which is displayed at terminal 23 is similar to web page 100 from lender 30, allowing lender 30 to maintain a presence at terminal 23 located at vendor 20.

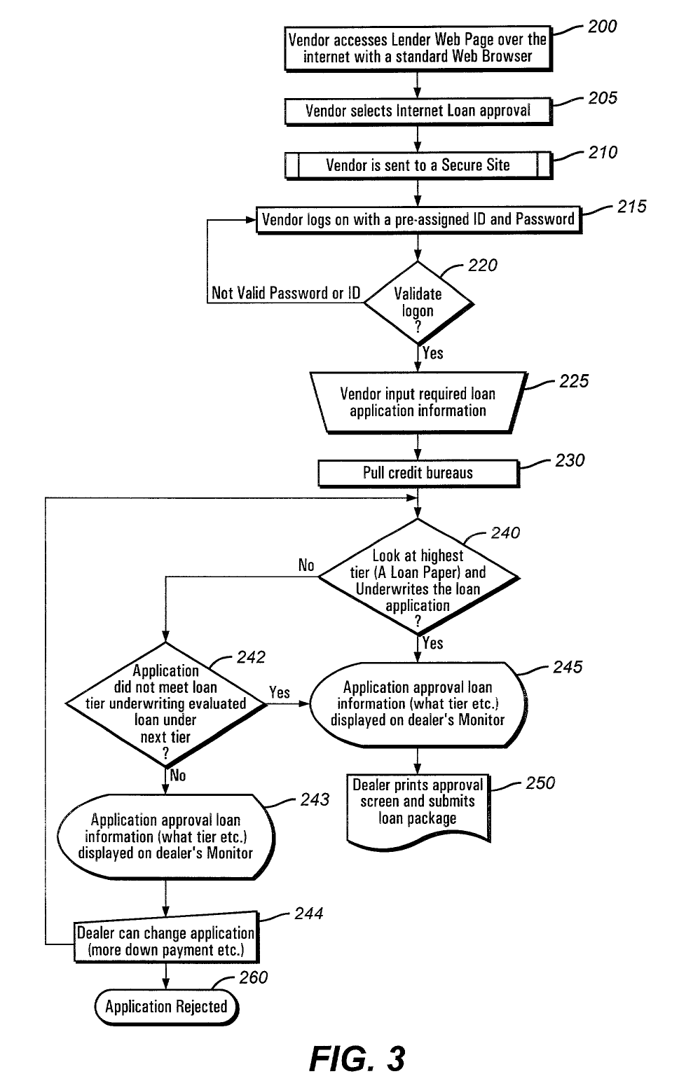

In the operation of the preferred embodiment, referring now to FIG. 3, a prospective borrower 10 is at vender 20 or has otherwise selected one or more goods to secure a loan. These goods may be offered for outright sale, for leasing, or for any other transaction that may secure or otherwise be funded by a loan. Vendor 20 accesses 200 lender 30 by accessing a web page associated with lender 30 over the Internet such as with a standard browser as that term is well understood by those of ordinary skill in the software arts. In the currently preferred embodiment, each vendor 20 will have a preexisting relationship established with each lender 30 with whom vendor 20 wishes to place loans before vendor 20 accesses lender 30. However, in other currently envisioned embodiments no preexisting relationship may exist or be required between vendor 20 and lender 30 and vendor 20 may establish a relationship with lender 30 in realtime. Further, no preexisting relationship may be required between borrower 10 and lender 30.

However, borrower 10 may request a specific lender 30 if borrower 10 has standing or a previous relationship with lender 30. If vendor 20 does not have a current relationship with that lender 30, vendor 20 may request a relationship online and in realtime according to predetermined criteria set out by lender 30, including signing vendor-lender contracts, as necessary, using electronic signatures or other appropriate means.

In a currently preferred embodiment, a selection mechanism will be accessible to vendor 20 such as by web 100 page at web site maintained by lender 30. The selection mechanism may be a selectable option such as a button or other selectable region on a displayed web page, e.g. region 102, or any other option selection method as will be readily familiar to those of ordinary skill in the software arts. In the preferred embodiment, upon selection 205 of the option, vendor 20 will be presented with a secure web page 210. The method of providing secure data communications links and secure pages is readily familiar to those of ordinary skill in the software arts.

It is anticipated that the lender 30 web page will have a frame, hyperlink, JAVA (R) applet, or other program transfer mechanism, or any combination thereof, which allows lender 30 to maintain a visual presence at the display on terminal 23 while seamlessly and transparently transferring operation to the present invention. This seamless or transparent display method therefore can make the loan application and approval process appear to be directly from lender 30.

In a preferred embodiment, vendor 20 logs into the present invention such as by a user identifier and password 215. This process maybe automated such as with registry entries at terminal 23 or the like. As illustrated in FIG. 2, login can be accomplished by use of a menu or a form region such as form region 102 on web page 100 or by any other means readily familiar to those of ordinary skill in the software arts.

Referring back to FIG. 3, the present invention validates the user identifier and password 220 of vendor 20 and rejects access if the user identifier and password are incorrect. No callbacks are is required but callbacks may be optionally implemented for additional security. Further, other optional security measures and devices may be employed, such as electronic signatures, encryption keys, finger scans, retinal scans, voice systems, or the like, or any combination thereof, all of which will be familiar to those of ordinary skill in the computer and software arts.

Once given access to the present invention, vendor 20 enters some or all of the borrower 10 and transaction data into one or more menus or screen forms 225 presented by lender 30.

Referring now to FIG. 4, once given access to the present invention, application access web page 110 may be presented to allow vendor 20 to retrieve a prior application or enter a new application, such as by menu form 111 or by any other means readily familiar to those of ordinary skill in the software arts. In this manner, numerous services may be provided to vendor 20 by lender 30 including pre-approvals, loan approvals, status inquiries, and the like.

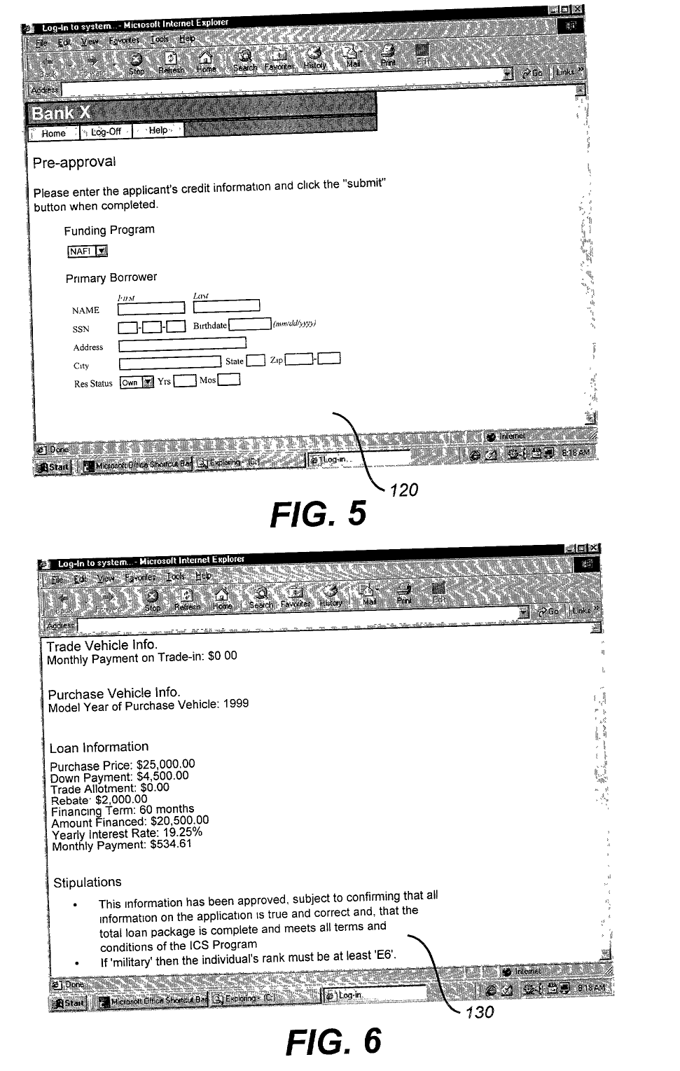

Referring now to FIG. 5, vendor 20, once gaining access to the system, may enter transaction data required such as data about borrower 10 and collateral data. Transaction data may include descriptions of the item sought to be financed. These descriptions may be entered by vendor 20 such as by transaction form 120. Additionally, external sources may be used for transaction data such as the National Automobile Dealers Association data for automobile and truck data or similar services.

Referring back to FIG. 3, the present invention validates the completeness of data about borrower 10 and transaction data and then obtains predetermined financial information 230 about prospective borrower 10 from one or more sources such as from credit bureaus. As used herein, “credit bureau” may be a source of credit information such as EQUIFAX (R), an external source of Is financial data such as DUN AND BRADSTREET (R) or the like, or a combination thereof. As further used herein, “financial information” may comprise credit history, payment history, corporate information, general demographic information, or the like, or any combination thereof.

As shown in steps 240 through 245, the transaction data and credit bureau data are combined and compared against the lender's 30 predetermined criteria for loan acceptance and approval, beginning with a predetermined initial tier 60. The present invention software examines the prospective borrower 10 information 240 and credit bureau information according to rule-based criteria maintained by the present invention for each of the prospective lenders 30. These criteria define rules for approval of the loan along with loan characteristics, e.g. interest rate. In this manner, the present invention does not, by itself, attempt to match lenders 30 and borrowers 10. Instead, the present invention processes each request according to rules available to the present invention but created and maintained by each lender 30.

If data about borrower 10, transaction data, and credit bureau data do not satisfy the initial tier 60 criteria, the data about borrower 10, transaction data, and credit bureau data may be compared to subsequent tiers 60 in a predetermined order until either a tier 60 is located for which the borrower data, transaction data, and credit bureau data meet that tier's 60 acceptance criteria or no more tiers 60 exist.

If an application is approved, loan approval information may be posted at an output device such as terminal 23 located at vendor 20 or provided to vendor 20 such as by electronic mail or facsimile. The notice comprises the tier 60 at which the loan is approved including tier 60 loan characteristics such as rate, duration of loan, and the like for that tier 60.

Referring now to FIG. 6, approval web page 130, here shown in partial detail, may display all pertinent information including stipulations and may further comprise details of the loan contract required by lender 30.

Referring back to FIG. 3, if no tier 60 criteria are satisfied, a rejection notice may be posted 243 at an output device such as terminal 23 located at vendor 20. The notice may comprise reasons for rejection at the final tier 60 processed. In alternative embodiments, all or some portion of all tiers 60 considered may be posted along with the corresponding rejection reasons on a tier 60 by tier 60 basis.

Borrowers 10 may be given an opportunity to modify 244 their data such as to increase a down payment or add additional sources of income or other collateral. If such modifications are made, the loan application is reprocessed, beginning at a predetermined tier 60.

If borrower 10 accepts the tier 60 loan approval, vendor 20 may obtain a hard copy of the loan approval information 250 such as by printing approval web page 130, selecting a print option which prints out borrower and loan information, electronic mail, facsimile, or the like, or a combination thereof. The hard copy may be obtained virtually immediately while borrower 10 is still at vendor 20.

In most embodiments, borrower 10 then signs the loan contract which is supplied by lender 30 to vendor 20 or is a contract supplied by vendor 20 and approved by lender 30. The information form and a package of loan information including the signed loan contract form are then submitted to lender 30 by vendor 20. The loan package may be delivered via regular mail, express mail, specialized delivery systems such as FEDERAL EXPRESS (R), electronically such as by facsimile or scanned documents, or electronically signed documents transmitted by electronic mail. In a currently envisioned embodiment, signatures of borrower 10, other required paperwork, or any combination thereof may be electronically transmitted to lender 30, including using electronic signatures.

In the preferred embodiment, the present invention cannot be directly accessed by an individual consumer borrower 10 such as to look for a loan or obtain a loan pre-approval. Potential borrowers 10 must go through a pre-approved lender 30 or vender 20.

Further, as opposed to prior art systems and methods that automatically match a best available loan to a potential borrower 10 via global telecommunications network, in the preferred embodiment the present invention does not match a best available loan from a plurality of loans to borrower 10 and let borrower 10 select from a set of loans. Instead, the present invention allows a vendor-lender relationship to be established to the mutual benefit of both vendor 20 and lender 30.

In alternative embodiments, the present invention may allow for venders 20 to initiate a relationship electronically with a lender 30 such as by signing necessary contracts online.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. A system for evaluating, approving, and underwriting loans for a borrower requesting a loan from a lender at a vendor location, comprising:
a. a computer system having a database, the database further comprising
i. data describing vendors approved to use the computer system;
ii. data describing lenders accessible to the computer system; and
iii. at least one tier comprising loan approval rules-based criteria for each lender accessible to the computer system;
b. a data communications network operatively in communications with the computer system, the data communications network further comprising at least one interface to one or more sources of financial information;
c. an input terminal, operatively connected to the computer system via the data communications network, for providing borrower information to the computer system, the borrower information comprising borrower personal data, borrower personal financial data, and data describing collateral to be financed;
d. loan approval software operatively resident in the computer system for evaluating the borrower information and information from the one or more sources of financial information according to the loan approval criteria and accepting or rejecting the borrower's request for a loan; and
e. an output device, operatively connected to the computer system via the data communications network, for displaying a result of the loan approval software.

2. The system of claim 1 where the data communications network is selected from the group of data communications networks consisting of the Internet, Intranets, synchronous dial-ups, asynchronous dialups, synchronous dedicated lines, asynchronous dedicated lines, and local area networks.

3. The system of claim 1 wherein the sources of financial information comprise credit reporting bureaus, external financial data sources, and sources of valuation data for a predetermined set of items.

4. A method of loan approval for a system for evaluating, approving, and underwriting loans for a borrower requesting a loan from a lender at a vendor location, the system comprising a computer system having a database that further comprises data describing vendors approved to use the computer system, data describing lenders accessible to the computer system, and at least one tier comprising loan approval rules-based criteria of each lender; a data communications network operatively in communications with the computer system, the data communications network comprising at least one interface to one or more sources of financial information; an input terminal, operatively connected to the computer system via the data communications network, for providing borrower information to the computer system, the borrower information comprising borrower personal data, borrower personal financial data, and data describing collateral to be financed; loan approval software operatively resident in the computer system for evaluating the borrower information and information from the one or more sources of financial information according to the approval criteria and accepting or rejecting the borrower's request for a loan; and an output device, operatively connected to the computer system via the data communications network, for displaying a result of the loan approval software, the method comprising:
a. having a vendor of an item to serve as collateral for a loan access a lender data screen at the input terminal, the lender data screen associated with a lender having preexisting relationship with the vendor;
b. obtaining a predetermined set of borrower information concerning the borrower, the borrower information comprising borrower personal data, borrower personal financial data, and collateral data
c. obtaining a predetermined set of data regarding the item;
d. selectively enabling the vendor with access to a loan approval portion of the lender data screen;
e. selectively enabling the vendor with access to a loan application input form comprising at least one data entry area;
f. inputting the borrower information and the data regarding the item into the data entry area;
g. transmitting the borrower information and the data regarding the item to an application validation process;
h. validating the borrower information and the data regarding the item as transmitted;
i. obtaining a predetermined set of credit information regarding the borrower;
j. for each tier, using predetermined loan approval rules-based criteria to compare the borrower information, the data regarding the item, and the credit information against the loan approval criteria associated with the lender in that tier until at least one tier's criteria are met or no more tiers exist;
k. if the borrower information, the data regarding the item, and the credit information satisfy a tier, notifying the vendor of the tier that has been satisfied;
l. if no tier is satisfied, notifying the vendor of a rejection of the borrower's request.

5. The method of claim 4 wherein the lender data screen is a web page accessible via an Internet communications link.

6. The method of claim 4 wherein the predetermined set of borrower information further comprises borrower income data and down payment data.

7. The method of claim 4 wherein the data regarding the item to be purchased further comprises data describing the item where the data are obtained from a source of external data for such items.

8. The method of claim 7 wherein the source of external data is an independent source of such information.

9. The method of claim 4 further comprising:
a. giving the borrower an opportunity to modify the borrower information; and
b. if such modifications are made, transmitting the modified borrower information to the loan approval evaluation software and reinitiating the comparison process at a predetermined tier.

10. The method of claim 9 wherein the borrower modification comprises changes to a down payment amount, sources or amounts of income, or other collateral to be used to secure a loan.

11. The method of claim 4 wherein selectively enabling the vendor with access to a loan application input form comprising at least one data entry area further comprises:
a. requiring entry of predetermined vendor security information; and
b. validating the vendor security information.

12. The method of claim 11 wherein the vendor security information is selected from the set of security information consisting of user names, passwords, electronic signatures, encryption keys, finger scans, retinal scans, and voice systems.

13. The method of claim 4 further comprising posting loan approval or rejection information at the output terminal.

14. The method of claim 13 wherein the posted loan approval or rejection information comprises properties of the tier at which the loan is approved or rejected.

15. The method of claim 14 wherein the properties of the tier at which the loan request is approved comprise annual interest percentage rate, duration of loan, and information required by statute to be present.

16. The method of claim 4, for approved loans, further comprising obtaining by the vendor of a hard copy of approval information.

17. The method of claim 16 wherein obtaining a hard copy is selected from the group of obtaining methods consisting of printing an approval screen, selecting a print option which prints out borrower and loan information, and selecting a print option for electronic delivery of borrower and loan information.

18. The method of claim 4 further comprising:
a. acceptance of the loan as offered by the lender by the borrower;
b. signing a loan approval form by the borrower; and
c. transmitting a package of loan information including the signed loan approval form to the lender.

19. The method of claim 18 in the borrower signs the loan approval form electronically.

20. The method of claim 4 wherein the predetermined credit information about the prospective borrower is obtained from one or more credit bureaus.

21. The method of claim 12, if no tier is satisfied, wherein the notification to the vendor of a rejection of the borrower's request comprises reasons for rejection at a last tier considered.

22. The method of claim 12, if no tier is satisfied, wherein the notification to the vendor of a rejection of the borrower's request comprises reasons for rejection for a predetermined number of considered tiers.

23. The method of claim 4 wherein the predetermined set of tiers comprises a plurality of tiers.

24. The method of claim 4 wherein each tier's properties further comprise properties for a predetermined set of product type classifications whereby each loan application may be processed differently at each tier based on a product type classification of the item for which the borrower is requesting a loan.

25. The method of claim 23 wherein the product type classifications are selected from the set of product type classifications consisting of automobiles, housing, mobile or manufactured housing, boats, medical goods, household goods, appliances, jewelry, and machinery.

26. The method of claim 4 wherein only a vendor is allowed to enter borrower attributes.

27. The method of claim 4 further comprising allowing a vendor to initiating a relationship electronically with at least one lender in realtime.

28. The method of claim 4 wherein financial information may be obtained from a source of financial information such as DUN AND BRADSTREET.

29. The method of claim 4 further comprising providing lenders with an ability to manipulate lending criteria for one or more tiers for that lender.

30. A computer program embodied within a computer-readable medium created using the method of claim 4.
